(19) United States
(12) Patent Application Publication
(10) Pub. No.: US 2005/0275512 A1
(43) Pub. Date: Dec. 15, 2005

(54) Image display device and installation device thereof

(75) Inventor: Isao Shimoyama, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/139,037

(22) Filed: May 27, 2005

(30) Foreign Application Priority Data
May 28, 2004 (JP) P.2004-158759

(51) Int. Cl. B60Q 1/00

(52) U.S. Cl. 340/435; 340/932.2; 348/148

(57) ABSTRACT

An image display device installed for a rear seat passenger of a vehicle, including: a display section for displaying an image information that includes an image of an outside rear part of the vehicle which is taken with a back camera; and a driving sensor for detecting that the vehicle is set to a rearward driving mode, wherein when the driving sensor detects the setting of the rearward driving mode, the display section is rotated to allow a driver who turns to a rear side of the vehicle to see the image of the outside rear part of the vehicle.

### CROSS REFERENCE OF RELATED APPLICATION

This application is based on and claims priority under 35 U.S.C. § 119 with respect to Japanese Patent Application No. 2004-158759 filed on May 28, 2004, the entire content of which is incorporated herein by reference.

### BACKGROUND OF THE INVENTION

The present invention relates to an image display device and an installation device thereof.

These days, a vehicle provided with a monitor system for displaying an output image from a navigation device, a TV tuner, a DVD player, etc., which includes a monitor for a front seat (a front monitor) installed adjacent to a dash board and a monitor for a rear seat (an image display device), has been disclosed in the related art (see JP-A-2004-90722).

A monitor system 1 described in JP-A-2004-90722 includes a front monitor 3 which is installed adjacent to a dash board 2, a back camera 5 which is installed on a roof panel above a rear seat 4, and an image display device 6 which is suspended from the roof panel in front of the rear seat 4.

In the monitor system 1, while a vehicle is in a forward driving mode, an output image from a navigation device, a TV tuner, etc. can be displayed on the front monitor 3 and/or the image display device 6. Meanwhile, while the vehicle is in a rearward driving mode, an image from the back camera 5 is displayed on the front monitor 3 so that an outside rear part of the vehicle can be checked from the image appearing on the front monitor 3.

Further, in the monitor system 1, while the vehicle travels rearward, the image display device 6 can be received in the roof panel so that the driver can directly view the outside rear part of the vehicle without being obstructed by the image display device 6.

As described above, in the conventional monitor system 1 which is provided with the back camera 5 for photographing the outside rear part of the vehicle, when the vehicle travels rearward, the driver can see through the front monitor 3 the image of the outside rear part of the vehicle which is obtained by the back camera 5.

In this regard, since the back camera 5 cannot properly photographs a dead spot and limitations necessarily exist in a display window size and a resolution of the front monitor 3, it is not preferred in view of safety that the driver drives the vehicle rearwards only relying on the image which is obtained by the back camera 5 and displayed on the front monitor 3.

For this reason, during rearward driving of the vehicle, while the driver faces forward and sees the front monitor 3 on which the image from the back camera 5 is displayed, it is necessary for the driver to sometimes turn around and directly check the outside rear part of the vehicle through a rear wind shield glass. Therefore, as a procedure in which the driver faces forward and turns around is repeated, difficulties are caused when driving the vehicle rearwards.

### SUMMARY OF THE INVENTION

The present invention has been made to solve the problems occurring in the related art, and an object of the present invention is to eliminate the difficulties which are caused when driving a vehicle rearwards due to the fact that a procedure in which a driver sees a front monitor on which an image from a back camera is displayed while facing forward and turns around to directly check an outside over the rear window of the vehicle is repeated.

According to a first aspect of the invention, there is provided an image display device installed for a rear seat passenger of a vehicle, including: a display section for displaying an image information that includes an image of an outside rear part of the vehicle which is taken with a back camera; and a driving sensor for detecting that the vehicle is set to a rearward driving mode, wherein when the driving sensor detects the setting of the rearward driving mode, the display section is rotated to allow a driver who turns to a rear side of the vehicle to see the image of the outside rear part of the vehicle.

According to a second aspect of the invention, there is provided an installation device for the image display device of the first aspect of the invention, including: a rotation mechanism for rotating the image display device; and a maintaining member for maintaining the rotation mechanism at a shaft of a headrest of a front seat of the vehicle.

### BRIEF DESCRIPTION OF THE DRAWINGS

These and other objects and advantages of this invention will become more fully apparent from the following detailed description taken with the accompanying drawings in which:

FIG. 1 is a view illustrating location of a conventional image display device;

FIG. 2 is a plan view illustrating an image display device and an installation device thereof in accordance with a first embodiment of the present invention;

FIG. 3 is a perspective view illustrating the image display device and the installation device thereof according to the first embodiment of the present invention;

FIG. 4 is an exploded view illustrating a main part of the image display device installation device according to the first embodiment of the present invention;

FIG. 5 is a perspective view illustrating an image display device and an installation device thereof in accordance with a second embodiment of the present invention; and

FIG. 6 is an exploded view illustrating a main part of the image display device installation device according to the second embodiment of the present invention.

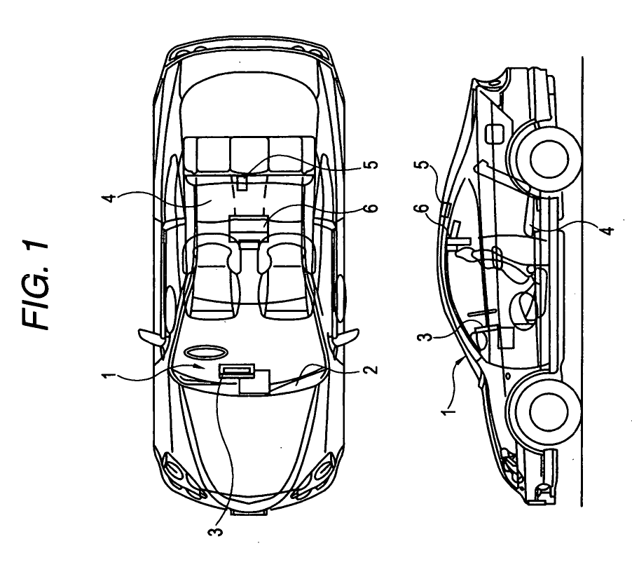

### DETAILED DESCRIPTION OF THE PREFERRED EMBODIMENTS

Hereafter, an image display device and an installation device thereof in accordance with preferred embodiments of the present invention will be described with reference to the attached drawings.

### First Embodiment

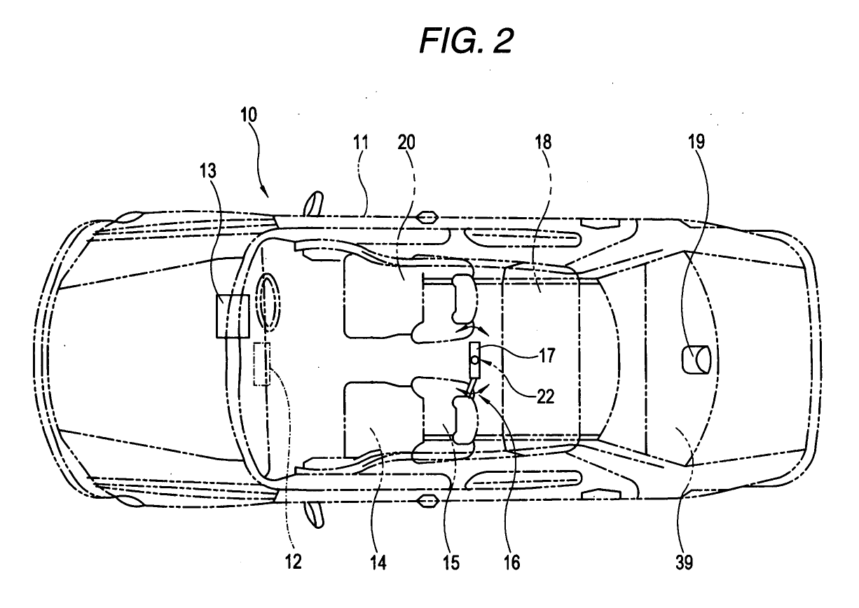

Referring to FIG. 2, a monitor system 10 provided to a vehicle 11 includes an image display device 17 which is installed to the seat back 15 of a front passenger seat 14 through an image display device installation device 16, and a back camera 19 which is installed (for example, on a roof panel behind a rear seat 18) to photograph an outside rear part of the vehicle 11. That is to say, the monitor system 10 in accordance with a first embodiment of the present invention as shown in FIG. 2 includes the image display device 17 and the installation device 16 thereof.

The monitor system 10 further includes a controller 12 for controlling display of an image from the back camera 19 and operation of a rotation mechanism 22.

A general front monitor 13 for displaying an output image from a navigation device, a TV tuner, a DVD player, etc. may be provided in front of a driver seat 20.

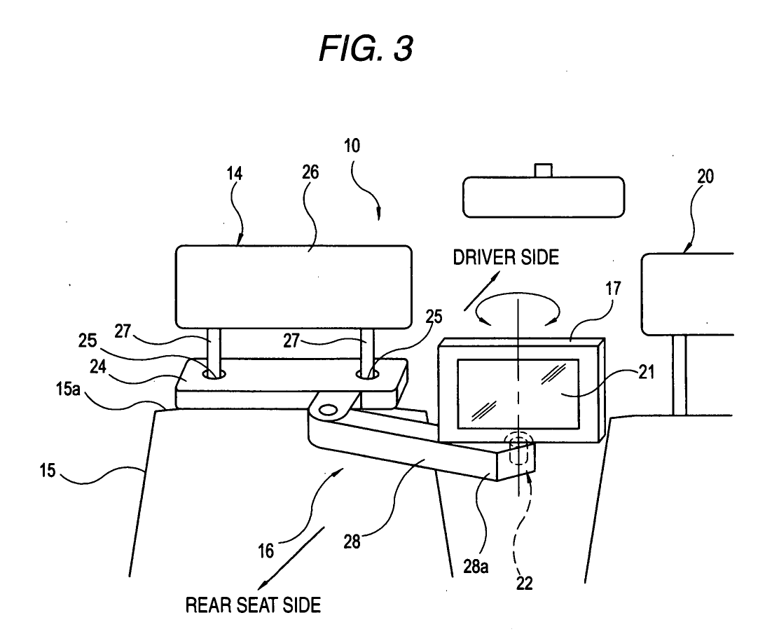

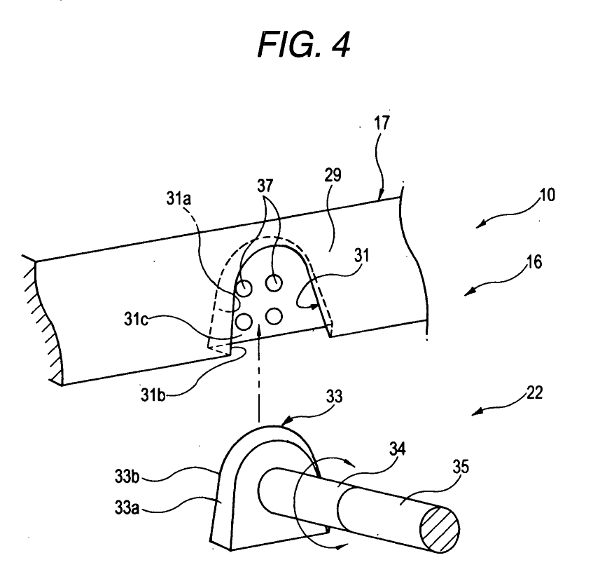

In the first embodiment of the present invention, the image display device installation device 16 is positioned at least more rearward than the driver seat 20 and includes the rotation mechanism 22 (see FIGS. 3 and 4) for rotating the image display device 17 to allow a display section 21 (see FIG. 3) of the image display device 17 to be seen from the driver seat 20 when a driver turns around.

A concrete example of the image display device installation device 16 will be described below. Referring to FIG. 3, a stay 24 is placed on the upper end 15a of the seat back 15 of the front passenger seat 14. The stay 24 is defined with a pair of holes 25. By respectively inserting a pair of shafts 27 of a headrest 26 through the pair of holes 25 of the stay 24, the stay 24 is installed on the upper end 15a of the seat back 15. An arm 28 is coupled to the stay 24, and the image display device 17 is installed to the distal end 28a of the arm 28 so that the image display device 17 can be freely rotated in directions shown by the arrows through the operation of the rotation mechanism 22.

As shown in FIG. 4, in the rotation mechanism 22, an insertion groove 31 is defined on the lower surface 29 of the image display device 17 in a manner such that an inner surface 31a which extends from a lowermost opening 31b of the insertion groove 31 to the bottom 31c of the insertion groove 31 is diverged. The rotation mechanism 22 includes an insertion part 33 which is inserted into the insertion groove 31. The edge of the insertion part 33 is formed as an inclined outer surface 33a in conformity with the inner surface 31a of the insertion groove 31. Due to this fact, when the insertion part 33 is inserted into the insertion groove 31, the insertion part 33 can be securely held in the insertion groove 31. A rod 34 is connected to the insertion part 33. The rod 34 is rotatably coupled to a support rod 35 which is installed to the distal end 28a (see FIG. 3) of the arm 28.

Terminals 37 serving as electrical contacts are placed on the bottom 31c of the insertion groove 31, and a surface 33b of the insertion part 33 which faces the bottom 31c of the insertion groove 31 is provided with contacts (not shown) which are brought into electric contact with the terminals 37.

Also, instead of arranging the electrical contacts on the bottom 31c of the insertion groove 31 and the insertion part 33, separate electrical wirings such as electric cords (not shown) may be used.

Due to the provision of the rotation mechanism 22, the image display device 17, which is installed at a position where a rear seat passenger can see the display section 21 while facing forward, can be rotated by about 180° so that the display section 21 can be seen by the driver when the driver turns around toward the rear part of the vehicle 11.

The display section 21 of the image display device 17 is constructed in a manner such that it can display an image from the back camera 19 which is installed to photograph the outside rear part of the vehicle 11. As a consequence, when the driver turns around toward the rear part of the vehicle 11, the driver can see the image from the back camera 19 which is displayed on the display section 21 of the image display device 17.

Further, the image display device 17 and the installation device 16 thereof are controlled in their operation by the controller 12 so that, when the vehicle 11 is set to travel rearward, the image from the back camera 19 is displayed on the image display device 17 and the image display device 17 is automatically rotated by about 180° toward the driver to allow the driver who turns around to see the image from the back camera 19.

A switch (not shown) for rotating the image display device 17 can be installed at a predetermined position. In this case, before driving the vehicle 11 in a rearward direction, the driver can manipulate the switch to rotate the image display device 17 so that the display section 21 faces the driver in advance. Then, as the vehicle 11 travels rearward, the image from the back camera 19 is displayed on the display section 21.

The image display device 17 according to this first embodiment of the present invention is installed for the rear seat passenger of the vehicle 11. The image display device 17 can display the image from the back camera 19 which is installed to photograph the outside rear part of the vehicle 11 and can allow the driver to see the image from the back camera 19 when the driver turns around toward the rear part of the vehicle 11. The image display device 17 is constructed to display the image from the back camera 19 when the vehicle 11 is set to a rearward traveling mode.

Since the image display device 17 of this preferred embodiment can be rotated by about 180°, it is possible to use a monitor display which is provided with the display section 21 only on one surface thereof.

In this preferred embodiment, because the monitor display can be attached to and detached from the image display device installation device 16, the existing monitor displays can be freely employed without departing from the scope and spirit of the present invention.

Also, in the present embodiment, although it becomes impossible to freely attach and detach the monitor display to and from the image display device installation device 16, it can be envisaged that the insertion groove 31 and the insertion part 33 are integrally constructed with each other, whereby the image display device 17 can be integrated with the image display device installation device 16.

Hereafter, operation of the monitor system 10 for the vehicle 11 which includes the image display device 17 and the image display device installation device 16 will be described.

In the monitor system 10 shown in FIG. 2, when the driver moves a shift lever (not shown) to a rearward (backward) driving position, that is, when gear shift to a back gear is effected in a transmission to allow rearward traveling of the vehicle 11, if an image is not displayed on the image display device 17 (that is, a power switch of the image display device 17 is turned off), the power switch of the image display device 17 is turned on. Then, the image from the back camera 19 is displayed on the image display device 17.

When the vehicle 11 is set to travel rearward, in the case that an image from a TV or DVD player is displayed on the image display device 17, the display of the image from the TV or DVD player is stopped, and instead, the image from the back camera 19 is displayed on the image display device 17.

At the same time, as the rotation mechanism 22 is controlled by the controller 12 to be driven, the image display device 17 is automatically rotated by about 180° so that the display section 21 of the image display device 17 faces the driver.

Therefore, as the driver turns around toward the rear part of the vehicle 11, the driver can directly check the rear part of the vehicle through a rear wind shield glass 39 (see FIG. 2) while seeing the image from the back camera 19 displayed on the display section 21 of the image display device 17. In this way, since the driver can drive the vehicle 11 rearward while facing the same rearward direction (toward the rear part of the vehicle 11), rearward driving of the vehicle 11 can be easily implemented.

Meanwhile, if the rearward travel of the vehicle 11 is stopped and the driver moves the shift lever to a forward driving position or a parking position, the display of the image from the back camera 19 on the display section 21 of the image display device 17 is ceased, and the image display device 17 returns to the previous condition before the shift lever is moved to the rearward driving position. Further, the rotation mechanism 22 is driven to automatically rotate the image display device 17 by about 180° so that the display section 21 of the image display device 17 can face the rear seat 18.

When actually driving the vehicle 11 rearward (for example, when parking the vehicle 11), gear shift manipulation is repeated several times in the forward and rearward directions in a manner such that the shift lever is moved to the forward driving position for a little while to allow the vehicle 11 to be slightly moved forward, and then, the shift lever is moved to the rearward driving position to allow the vehicle 11 to be moved rearward to be properly parked in a parking lot. At this time, since switching of the image display of the image display device 17 and operation of the rotation mechanism 22 are continuously repeated, operational reliability of the monitor system 10 can be deteriorated. In this consideration, in the present invention, the monitor system 10 can be controlled in a manner such that, only when a speed of the vehicle 11 exceeds a predetermined speed (or a predetermined time is lapsed) after the shift lever is moved to the forward driving position, the display condition of the image display device 17 can return to an original state and the image display device 17 can be rotated to allow the display section 21 of the image display device 17 to face rearward.

Also, the display of the image from the back camera 19 and the rotation of the image display device 17 can be implemented after the rearward travel of the vehicle 11 is sensed. For example, when the rearward travel of the vehicle 11 is sensed using a sensor for sensing a rotating direction or a speed of a wheel of the vehicle 11, the display of the image from the back camera 19 and the rotation of the image display device 17 can be implemented.

Moreover, the rotation mechanism 22 for rotating the image display device 17 can be constructed to manually rotate the image display device 17. In this case, before driving the vehicle 11 rearward, it is necessary to manually rotate the image display device 17 so that the display section 21 of the image display device 17 faces the driver seat 20. Also, it can be envisaged that switching (turning-on or turning-off of the display of the image from the back camera 19) the display state of the display section 21 is effected through manipulation of a manual switch (not shown) by the driver.

### Second Embodiment

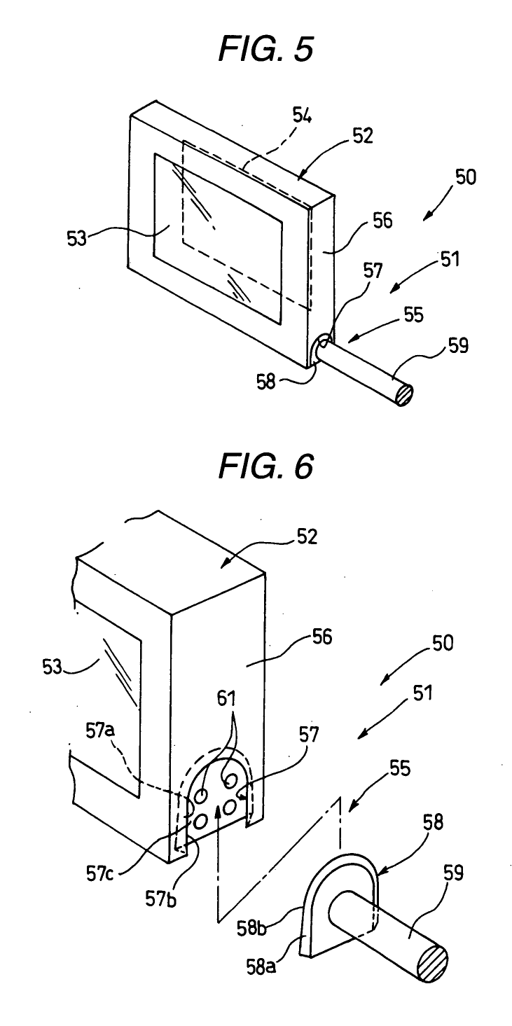

Next, an image display device 52 and an image display device installation device 51 in accordance with a second embodiment of the present invention will be described with reference to FIGS. 5 and 6. In this second embodiment of the present invention, the component parts which are the same as those of the first embodiment will be designated by the same reference numerals as those of the first embodiment.

A monitor system 50 according to this second embodiment is constructed in the same manner as the monitor system 10 according to the first embodiment aforementioned above, except a structure by which an image display device 52 is installed to the seat back 15 of the front passenger seat 14 (see FIG. 2) through an image display device installation device 51.

Differently from the image display device 17 of the first embodiment, the image display device 52 of the second embodiment as shown in FIG. 5 is provided with display sections 53 and 54 on its front and rear surfaces thereof.

The image display device installation device 51 of the second embodiment is positioned at least rearward of the driver seat 20 (see FIG. 2) and installs the image display device 52 in a manner such that the rear seat passenger seating on the rear seat 18 can see the display section 53 of the image display device 52 and the driver seating on the driver seat 20 can see the display section 54 of the image display device 52 when the driver turns around toward the rear part of the vehicle 11.

A concrete example of the image display device installation device 51 will be described below.

As in the image display device installation device 16 according to the first embodiment as shown in FIG. 3, in the image display device installation device 51 according to this second embodiment, a stay 24 is placed on the upper end 15a of the seat back 15 of the front passenger seat 14. The stay 24 is defined with a pair of holes 25. By respectively inserting a pair of shafts 27 of a headrest 26 through the pair of holes 25 of the stay 24, the stay 24 is installed on the upper end 15a of the seat back 15. An arm 28 is coupled to the stay 24.

Also, in the image display device installation device 51, as shown in FIG. 5, the image display device 52 is installed to the arm 28 through a support mechanism 55.

As shown in FIG. 6, in the support mechanism 55, an insertion groove 57 is defined on the side surface 56 of the image display device 52 in a manner such that an inner surface 57a which extends from a lowermost opening 57b of the insertion groove 57 to the bottom 57c of the insertion groove 57 is diverged. The support mechanism 55 includes an insertion part 58 which is inserted into the insertion groove 57. The edge of the insertion part 58 is formed as an inclined surface 58a in conformity with the inner surface 57a of the insertion groove 57. Due to this fact, when the insertion part 58 is inserted into the insertion groove 57, the insertion part 58 can be securely held in the insertion groove 57. A support rod 59 is connected to the insertion part 58. The support rod 59 is installed to the distal end 28a (see FIG. 2) of the arm 28.

Terminals 61 serving as electrical contacts are placed on the bottom 57c of the insertion groove 57, and a surface 58b of the insertion part 58 which faces the bottom 57c of the insertion groove 57 is provided with contacts (not shown) which are brought into electric contact with the terminals 61.

Also, instead of arranging the electrical contacts on the bottom 57c of the insertion groove 57 and the surface 58b of the insertion part 58, separate electrical wirings such as electric cords (not shown) may be used.

The image display device 52 according to this second embodiment of the present invention is installed for the rear seat passenger of the vehicle 11 and has the display section 53 on one surface which can be seen by the rear seat passenger and the display section 54 on the other surface which can be seen by the driver when the driver turns around.

In the image display device 52, the display section 54 facing the driver seat 20 can display the image from the back camera 19 which is installed to photograph the outside rear part of the vehicle 11. Also, when the driver turns around the rear part of the vehicle 11, the driver can see the image from the back camera 19 displayed on the display section 54 which faces the driver seat 20.

In addition, the image display device 52 is constructed so that, when the vehicle 11 is set to the rearward traveling mode, the image from the back camera 19 can be automatically displayed on the display section 54 which can be seen by the driver.

Due to the fact that the image from the back camera 19 can be automatically displayed on the display section 54 which can be seen by the driver, the driver can concentrate attention on driving.

Also, the image display device 52 can be constructed in a manner such that, when it is necessary to drive the vehicle 11 in the rearward direction, a manual switch (not shown) can be manipulated to allow the image from the back camera 19 to be automatically displayed on the display section 54 which can be seen by the driver.

As in the case of the first embodiment, in the image display device installation device 51 according to this second embodiment, since the monitor display can be freely attached to and detached from the image display device installation device 51, the existing monitor displays having display sections on both surfaces thereof can be freely employed as the image display device 52 according to this second embodiment of the present invention without departing from the scope and spirit of the present invention.

Also, in the image display device 52 of the present embodiment, although it becomes impossible to freely attach and detach the monitor display to and from the image display device installation device 51, it can be envisaged that the insertion groove 57 and the insertion part 58 are integrally constructed with each other, whereby the monitor display can be integrated with the image display device installation device 51.

Hereafter, operation of the monitor system 50 for the vehicle 11 which includes the image display device 52 and the image display device installation device 51 will be described.

In the monitor system 50 shown in FIGS. 5 and 6, when the driver moves a shift lever (not shown) to a rearward driving position, that is, when gear shift to a back gear is effected in a transmission to allow rearward traveling of the vehicle 11, the image from the back camera 19 is displayed on the display section 54 of the image display device 52 which faces the driver seat 20.

Therefore, as the driver turns around toward the rear part of the vehicle 11, the driver can directly check the rear part of the vehicle through a rear wind shield glass 39 (see FIG. 2) while seeing the image from the back camera 19 displayed on the display section 54 of the image display device 52. In this way, since the driver can drive the vehicle 11 rearward while facing the same rearward direction (toward the rear part of the vehicle 11), rearward driving of the vehicle 11 can be easily implemented.

Meanwhile, if the rearward travel of the vehicle 11 is stopped and the driver moves the shift lever to a forward driving position or a parking position, the display of the image from the back camera 19 on the display section 54 of the image display device 52 is ceased, and the image display device 52 returns to the previous condition before the shift lever is moved to the rearward driving position.

When actually driving the vehicle 11 rearward (for example, when parking the vehicle 11), gear shift manipulation is repeated several times in the forward and rearward directions in a manner such that the shift lever is moved to the forward driving position for a little while to allow the vehicle 11 to be slightly moved forward, and then, the shift lever is moved to the rearward driving position to allow the vehicle 11 to be moved rearward to be properly parked in a parking lot. At this time, since switching of the image display of the image display device 52 is continuously repeated, operational reliability of the monitor system 50 can be deteriorated. In this consideration, in the present invention, the monitor system 50 can be controlled in a manner such that, only when a speed of the vehicle 11 exceeds a predetermined speed (or a predetermined time is lapsed) after the shift lever is moved to the forward driving position, the display condition of the image display device 52 can return to an original state.

Also, the display of the image from the back camera 19 can be implemented after the rearward travel of the vehicle 11 is sensed. For example, when the rearward travel of the vehicle 11 is sensed using a sensor for sensing a rotating direction or a speed of a wheel of the vehicle 11, the display of the image from the back camera 19 can be implemented.

Moreover, it can be envisaged that display switching (turning-on or turning-off of the display of the image from the back camera 19) of the display section 54 of the image display device 52 is effected through manipulation of a manual switch (not shown) by the driver.

In this embodiment of the present invention, since the image display device 52 is provided on both surfaces thereof with the display sections (that is, the display section 53 facing the rear seat 18 and the display section 54 facing the driver seat 20), even in the case that an image from a TV or a DVD player is displayed on the display section 53 facing the rear seat 18, in a state in which the display on the display section 53 can be maintained as it is, the image from the back camera 19 can be displayed on the display section 54.

In the first and second embodiments of the present invention, while the back camera 19 is installed as shown in FIG. 2 to photograph the outside rear part of the vehicle 11, the back camera 19 can be installed at another place, a photographing direction can be changed, or a plurality of back cameras can be installed so that an image can be appropriately selected. For example, a camera for photographing the front part of the vehicle 11 can be installed, so that, when parking the vehicle in a parking lot, the image from the front camera can be displayed on the image display device 17 and 52.

As is apparent from the above description, the image display devices 17 and 52 according to the first and second embodiments which are installed for the rear seat passenger can display the image from the back camera 19 installed to photograph the outside rear part of the vehicle 11 and is constructed to allow the driver to see the image from the back camera 19 when the driver turns around the rear part of the vehicle 11. Due to this fact, since the image display devices 17 and 52 on which the image from the back camera 19 is displayed are positioned in the same rearward direction toward the rear part of the vehicle 11, when driving the vehicle 11 in the rearward direction, the driver can drive the vehicle 11 rearward while facing the same rearward direction.

1. An image display device installed for a rear seat passenger of a vehicle, comprising:
a display section for displaying an image information that includes an image of an outside rear part of the vehicle which is taken with a back camera; and
a driving sensor for detecting that the vehicle is set to a rearward driving mode, wherein
when the driving sensor detects the setting of the rearward driving mode, the display section is rotated to allow a driver who turns to a rear side of the vehicle to see the image of the outside rear part of the vehicle.

2. The image display device according to claim 1, further comprising
a rotation mechanism for rotating the display section which faces the rear side of the vehicle to allow the driver to see the display section.

3. The image display device according to claim 1, wherein
when the driving sensor detects the setting of the rearward driving mode, the display section displays the image of the outside rear part of the vehicle.

4. The image display device according to claim 2, wherein
when the driving sensor detects the setting of the rearward driving mode, the display section displays the image of the outside rear part of the vehicle, and the rotation mechanism automatically rotates the display section.

5. An image display device installed for a rear seat passenger of a vehicle, comprising
a display section for displaying an image information that includes an image of an outside rear part of the vehicle which is taken with a back camera, wherein
the display section includes:
a front side display section which faces the front side of the vehicle; and
a rear side display section which faces the rear side of the vehicle; and
the front side display section displays the image of the outside rear part of the vehicle to allow a driver who turns to the rear side of the vehicle to see the image.

6. An installation device for an image display device installed for a rear seat passenger of a vehicle, comprising:
a rotation mechanism for rotating the image display device; and
a maintaining member for maintaining the rotation mechanism at a shaft of a headrest of a front seat of the vehicle, wherein:
the image display device includes: a display section for displaying an image information that includes an image of an outside rear part of the vehicle which is taken with a back camera; and a driving sensor for detecting that the vehicle is set to a rearward driving mode; and
when the driving sensor detects the setting of the rearward driving mode, the display section is rotated to allow a driver who turns to a rear side of the vehicle to see the image of the outside rear part of the vehicle.

7. The installation device according to claim 6,
when the driving sensor detects the setting of the rearward driving mode, the rotation mechanism automatically rotates the display section to allow the driver seating on the driver seat of the vehicle to see the display section.
